(19) United States
(12) Patent Application Publication
(10) Pub. No.: US 2015/0062901 A1
(43) Pub. Date: Mar. 5, 2015

(54) Flexible Power Strip for Lamp

(71) Applicant: Te-Lung Chen, Tainan City (TW)

(72) Inventor: Te-Lung Chen, Tainan City (TW)

(21) Appl. No.: 14/017,348

(22) Filed: Sep. 4, 2013

(51) Int. Cl. F21V 21/14; F21K 99/00

(52) U.S. Cl. CPC F21V 21/14; F21K 9/30
USPC 362/249.04

(57) ABSTRACT

A flexible power strip for a lamp contains a flexible body, at least one electric circuit unit, at least one LED light element, and any one of an adjusting member, a hooking member, a weight member and a lamp. The flexible body has the at least one electric circuit unit arranged on at least one surface thereof so as to form a flexible power strip, and the flexible power strip is connected with the at least one LED light element so as to form a flexible lighting strip, the flexible power strip is coupled with the flexible lighting strip parallelly or crosswisely so as to produce a flexible lamp. The flexible body has a plurality of holes, and one of the plurality of holes hooks with any one of the hooking member, the weight member and the lamp so that the flexible lamp becomes curved.

### FIELD OF THE INVENTION

The present invent relates to a flexible power strip which is connected with at least one LED light element so as to form a flexible lighting strip or is coupled with the flexible lighting strip so as to produce a flexible lamp.

### BACKGROUND OF THE INVENTION

As shown in FIG. 1, a conventional flexible lighting strip 5 of a LED lamp is used to decorate objects, such as decoration elements of motorcycle, vehicle or clothes. However, such a conventional flexible lighting strip 5 cannot recover its original shape after being bent. Referring to FIG. 2, a snake light is supported by a flexible tube 6 and is bent to adjust an illuminating angle. Nevertheless, the flexible tube 6 cannot recover its original shape after being bent as well.

With reference to FIGS. 3 and 4, a conventional fishing lamp 1 contains a base 10, a plurality of upright supports 11, an arcuate support 12, and a lighting member 13. But such a conventional fishing lamp has the following disadvantages:

1. The fishing lamp is fixed, so it cannot be adjusted toward a desired height.

2. The fishing lamp cannot vary using types on a basis of use requirements.

3. The fishing lamp is stored in a large size.

The present invention has arisen to mitigate and/or obviate the afore-described disadvantages.

### SUMMARY OF THE INVENTION

The primary object of the present invention is to provide a flexible power strip which is connected with at least one LED light element so as to form a flexible lighting strip or is coupled with the flexible lighting strip so as to produce a flexible lamp, thus varying using type based on use requirements.

The secondary object of the present invention is to provide a flexible power strip which is coupled with the flexible lighting strip so as to produce a flexible lamp, and a height and a radian of the flexible lamp are adjusted by ways of any one of an adjusting member, a hooking member, a weight member and a lamp.

Further object of the present invention is to provide a flexible power strip which is started by direct current or alternating current, so at least one electric circuit unit can match with the flexible lighting strip or lamps, such as a table lamp, a fishing lamp, or a camping lamp.

Another object of the present invention is to provide a flexible power strip which is disassembled easily and is stored in a small size.

To obtain the above objectives, a flexible power strip for a lamp contains: a flexible body, at least one electric circuit unit, at least one LED light element, and any one of an adjusting member, a hooking member, a weight member and a lamp.

The flexible body has the at least one electric circuit unit arranged on at least one surface thereof so as to form a flexible power strip, and the flexible power strip is connected with the at least one LED light element so as to form a flexible lighting strip, the flexible power strip is coupled with the flexible lighting strip parallelly or crosswisely so as to produce a flexible lamp.

The flexible body has a plurality of holes, and one of the plurality of holes hooks with any one of the hooking member, the weight member and the lamp so that the flexible lamp becomes curved.

One end of the flexible lamp is inserted into a notch of the adjusting member and is locked by a locking element of the adjusting member, such that the adjusting member is coupled with the flexible lamp.

### BRIEF DESCRIPTION OF THE DRAWINGS

FIG. 1 is a plan view of a conventional flexible lighting strip.

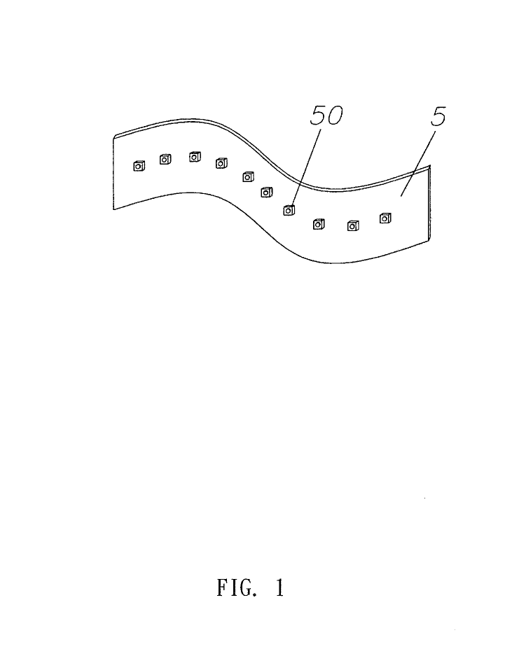

FIG. 2 is a perspective view of the conventional flexible lighting strip.

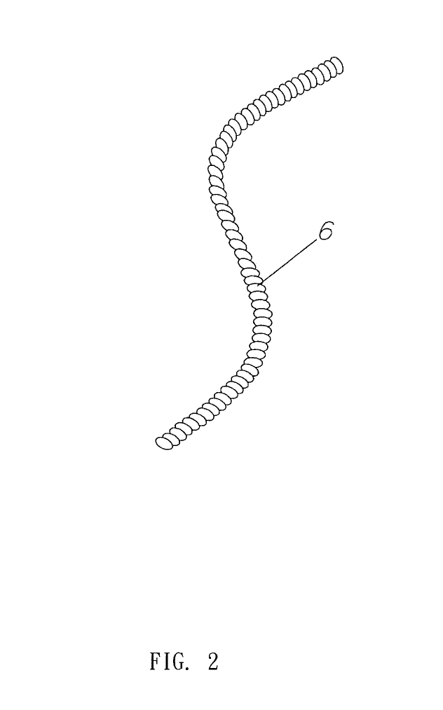

FIG. 3 is a perspective view of a conventional fishing lamp.

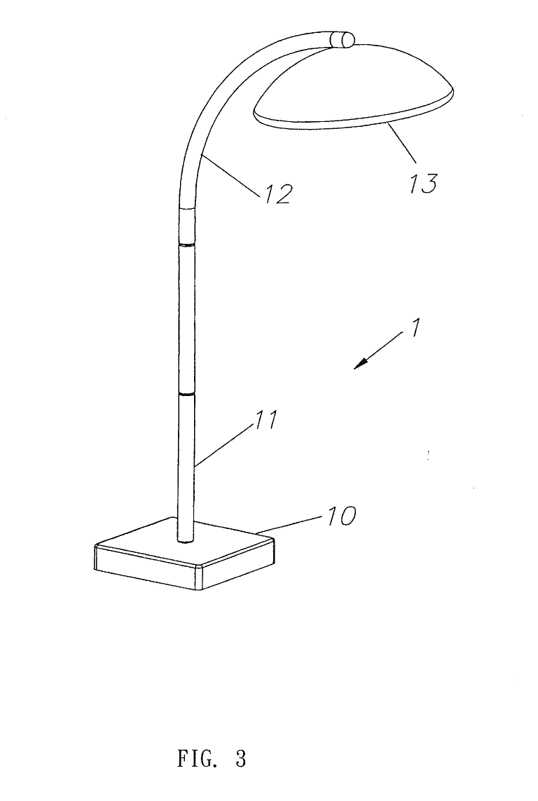

FIG. 4 is a perspective view showing the conventional fishing lamp being disassembled.

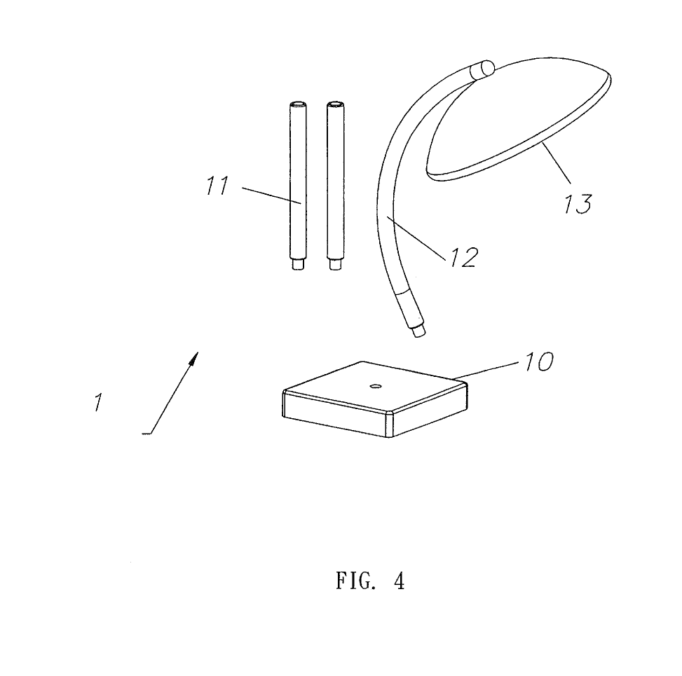

FIG. 5 is a perspective view showing the assembly of a flexible power strip for a lamp according to a first embodiment of the present invention.

FIG. 6 is a perspective view showing the application of the flexible power strip for the lamp according to the first embodiment of the present invention.

FIG. 7 is another perspective view showing the application of the flexible power strip for the lamp according to the first embodiment of the present invention.

FIG. 8 is a perspective view showing the application of an adjusting member of the flexible power strip for the lamp according to the first embodiment of the present invention.

FIG. 9 is a perspective view showing the exploded components of a flexible power strip for a lamp according to a second embodiment of the present invention.

FIG. 10 is a perspective view showing the assembly of the flexible power strip for the lamp according to the second embodiment of the present invention.

FIG. 11 is a perspective view showing the operation of the flexible power strip for the lamp according to the second embodiment of the present invention.

FIG. 12 is a perspective view showing the assembly of a flexible power strip for a lamp according to a third embodiment of the present invention.

FIG. 13 is a perspective view showing the operation of the flexible power strip for the lamp according to the third embodiment of the present invention.

FIG. 14 is a perspective view showing the application of the flexible power strip of the present invention.

FIG. 15 is a perspective view showing another application of the flexible power strip of the present invention.

### DETAILED DESCRIPTION OF THE PREFERRED EMBODIMENTS

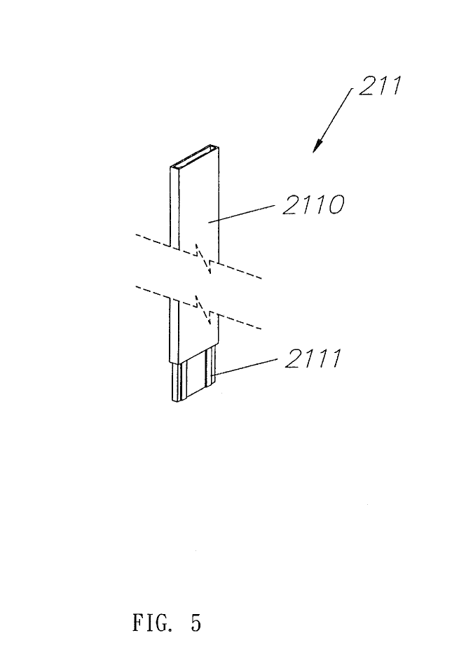

With reference to FIG. 5, a flexible power strip 211 for a lamp according to a first embodiment of the present invention comprises: a flexible body 2110 and at least one electric circuit unit 2111, wherein the flexible body 2110 is made of glass fiber, carbon fiber or a composite material and has the at least one electric circuit unit 2111 arranged on at least one surface thereof.

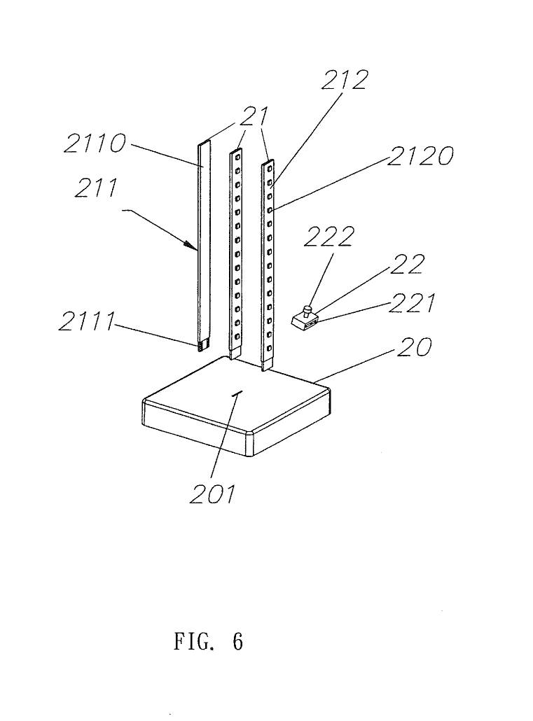

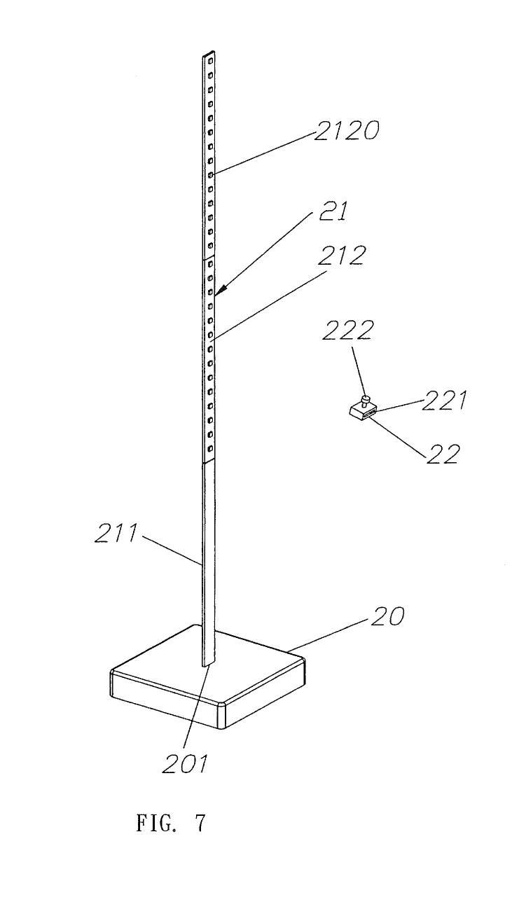

Referring to FIGS. 6 and 7, the flexible power strip 211 is connected with at least one light element 2120, such as light emitting diode (LED), so as to form a flexible lighting strip 212. In addition, the flexible power strip 211 is also coupled with the flexible lighting strip 212 parallelly or crosswisely so as to produce a flexible lamp 21.

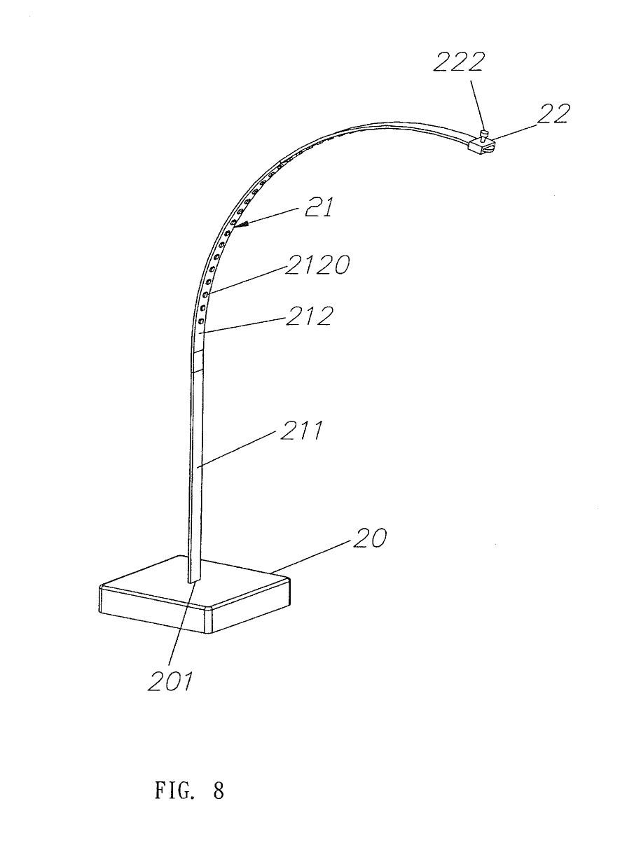

As shown in FIGS. 7 and 8, in use, a first end of the flexible lamp 21 is inserted into a recess 201 of a base 20, and a second end of the flexible lamp 21 is inserted into a notch 221 of an adjusting member 22 and is locked by a locking element 222 of the adjusting member 22, such that the adjusting member 22 is coupled with the flexible lamp 21. Thereby, when the adjusting member 22 presses the flexible lamp 21 downwardly by using its weight, the flexible lamp 21 becomes curved. The adjusting member 22 moves on the flexible lamp 21 so as to change a locking position and a locking number, thereby adjusting a height and a radian of the flexible lamp 21. It is to be noted that the flexible lamp 21 can be also bent in other curving manner.

As shown in FIG. 6, when desiring to store the flexible lamp 21, the adjusting member 22 is removed from the flexible lamp 21, and then the flexible lamp 21 is removed from the base 20, thereafter the flexible power strip 211 and the flexible lighting strip 212 of the flexible lamp 21 are disconnected from each other, thus storing the flexible lamp 21 in a small size easily.

The flexible power strip 211 is connected with the flexible lighting strip 212, such that the flexible power strip 211 and the flexible lighting strip are fixed on the base 20, thereafter the adjusting member 22 is used to adjust the radian of the flexible lamp 21, thus varying using types based on use requirements.

The at least one electric circuit unit 2111 of the flexible power strip 211 is started by direct current or alternating current, so the at least one electric circuit unit 2111 can match with the flexible lighting strip 212 or lamps, such as a table lamp or a fishing lamp. When the at least one electric circuit unit 2111 matches with the table lamp, the table lamp is fixed on the base 20 or is clamped on the table by ways of a fixture for replacing the base 20. Moreover, the flexible power strip 211 can cooperate with the flexible lighting strip 212 so as to form a camping lamp or the fishing lamp.

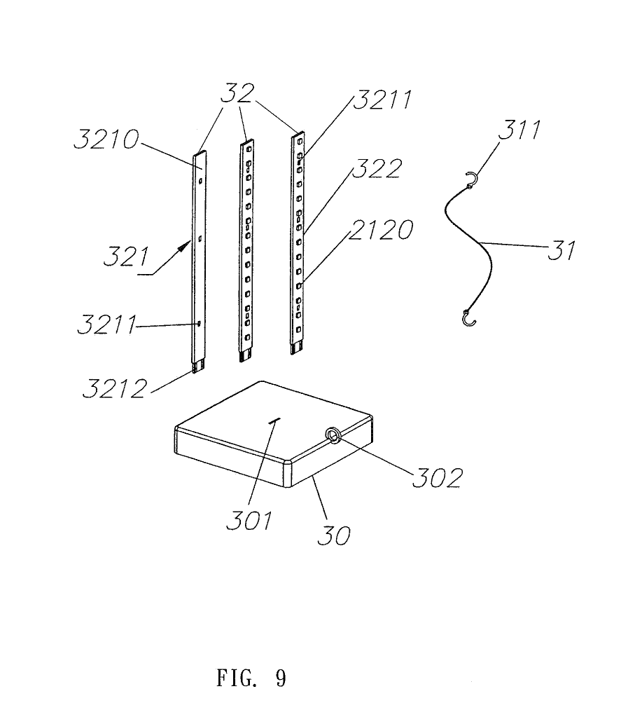

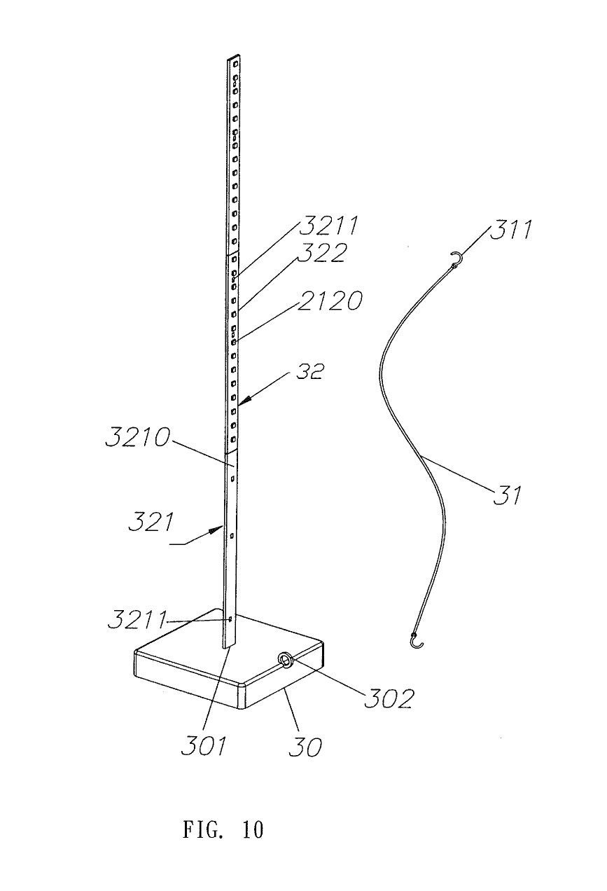

As illustrated in FIGS. 9 and 10, a difference of a flexible power strip 321 for a lamp of a second embodiment from that of the first embodiment comprises: a flexible body 3210 with a plurality of holes 3211 and at least one electric circuit unit 3212, wherein the flexible power strip 321 is connected with at least one light element 2120, such as light emitting diode (LED), so as to form a flexible lighting strip 322. In addition, the flexible power strip 321 is also coupled with the flexible lighting strip 322 parallelly or crosswisely so as to produce a flexible lamp 32.

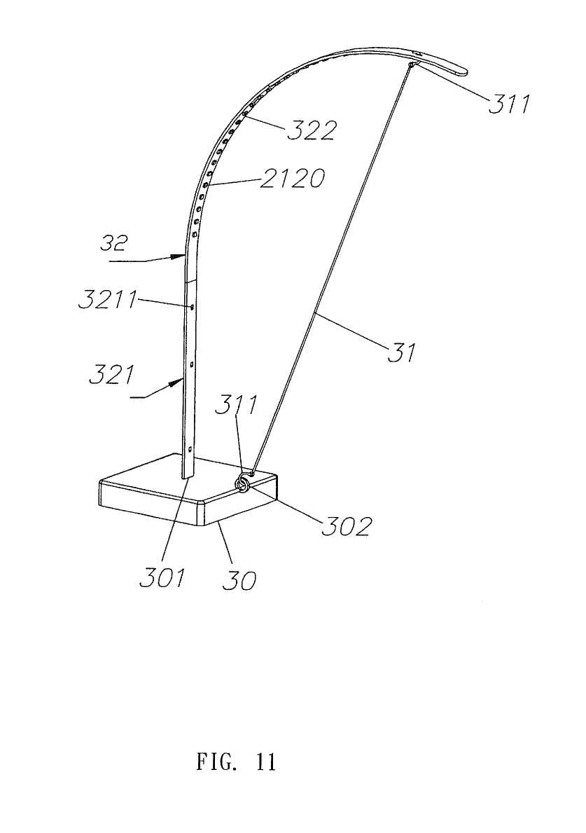

As shown in FIGS. 10 and 11, in use, a first end of the flexible lamp 32 is inserted into a recess 301 of a base 30, a hook 311 on a first end of a hooking member 31 is selectively hooked with one of the plurality of holes 3211, and a hook 311 on a second end of the hooking member 31 is hooked with a fixing ring 302 of the base 30, such that the flexible lamp 32 becomes curved. The hook 311 on the first end of the hooking member 31 is selectively hooked with one of the plurality of holes 3211, thereby adjusting a height and a radian of the flexible lamp 32.

It is to be noted that one of the plurality of holes 3211 can be hooked with a weight member or other lamps so as to bend the flexible lamp 32. By changing a hanging position and a hanging quantity of the weight member or other lamps, the height and the radian of the flexible lamp 32 are adjusted.

As shown in FIG. 9, when desiring to store the flexible lamp 32, two hooks 311 on the first end and the second end of the hooking member 31 are removed from the flexible lamp 32 and the base 30, and then the flexible flexible lamp 32 is removed from the base 30, thereafter the flexible power strip 321 and the flexible lighting strip 322 of the flexible lamp 32 are disassembled, thus storing the flexible lamp 32 in a small size easily.

The flexible power strip 321 is connected with the flexible lighting strip 322, such that the flexible power strip 321 and the flexible lighting strip 322 are fixed on the base 30. Thereafter, the hooking member 31, the weight member or other lamps are used to adjust the radian of the flexible lamp 32. Moreover, a plurality of flexible lighting strips 322 are coupled together and then are fixed on the base 30, and then the hooking member 31, the weight member or other lamps are applied to adjust the radian of the flexible lamp 32, thus varying using types of the flexible lighting strips 322 based on us requirements.

The at least one electric circuit unit 3221 of the flexible power strip 321 is started by direct current or alternating current, so the at least one electric circuit unit 3212 can match with the flexible lighting strip 322 or lamps, such as a table lamp or a fishing lamp. When the at least one electric circuit unit 3212 matches with the table lamp, the table lamp is fixed on the base 30 or is clamped on the table by ways of a fixture for replacing the base 30. Furthermore, the flexible power strip 321 can cooperate with the flexible lighting strip 322 so as to form a camping lamp or the fishing lamp.

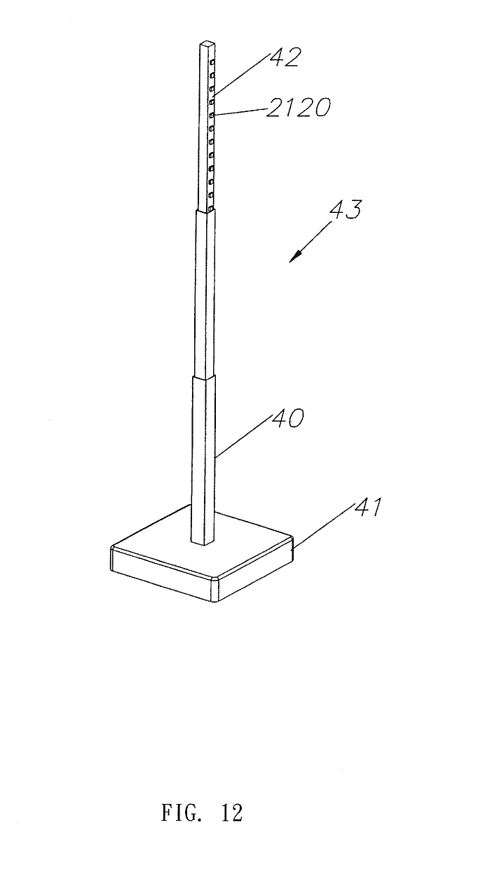

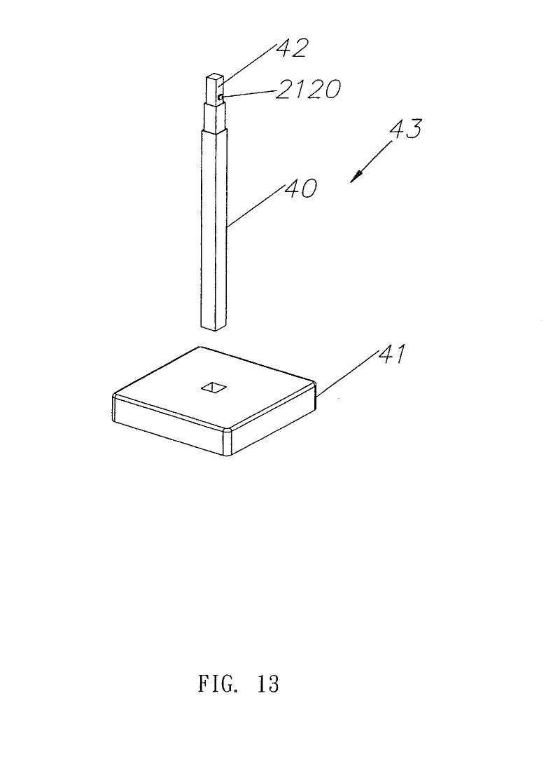

With reference to FIGS. 12 and 13, a difference of a flexible power strip for a lamp of a third embodiment from those of the first embodiment and the second embodiment comprises: a flexibly telescopic power pole 40 for replacing the flexible power strip 211 of the first embodiment and the flexible power strip 321 of the second embodiment, wherein at least one electric circuit unit (not shown) is arranged on at least one surface of the flexibly telescopic power pole 40, and wherein the flexibly telescopic power pole 40 is connected with at least one light element 2120, such as light emitting diode (LED), so as to form a flexibly telescopic lighting pole 42. In addition, the flexibly telescopic power pole 40 is coupled with the flexibly telescopic lighting pole 42 parallelly or crosswisely so as to produce a flexibly telescopic lamp 43. After the flexibly telescopic lamp 43 is connected with a base 41, it is extended outwardly, and any one of the adjusting member 22, the hooking member 31, other lamps and the weight member is used for bending the flexibly telescopic lamp 43. It is to be noted that the flexibly telescopic lamp 43 is removed from the base 41 so as to be stored in a small size easily.

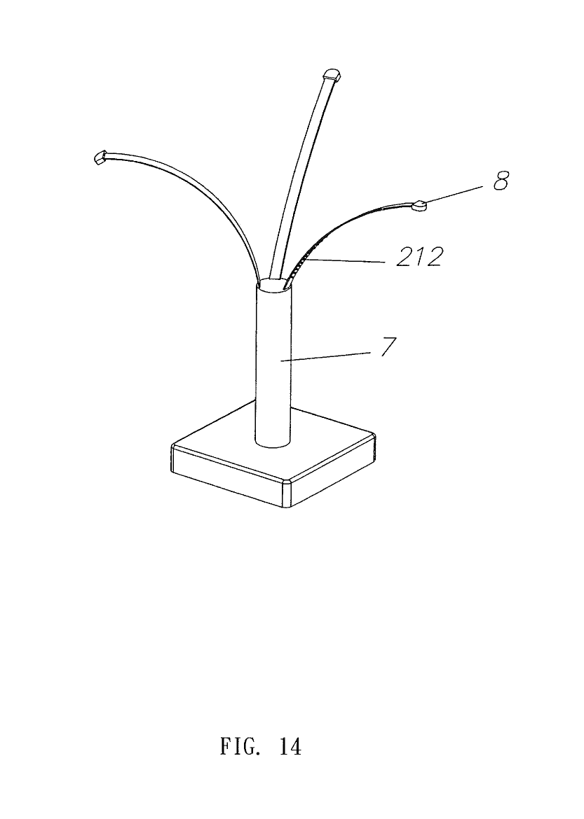

Referring further to FIG. 14, a plurality of flexible lighting strips 212 are connected with a lamp stand 7, and a weight member 8 is hanged on a distal end of each flexible lighting strip 212, thus forming a stand lamp.

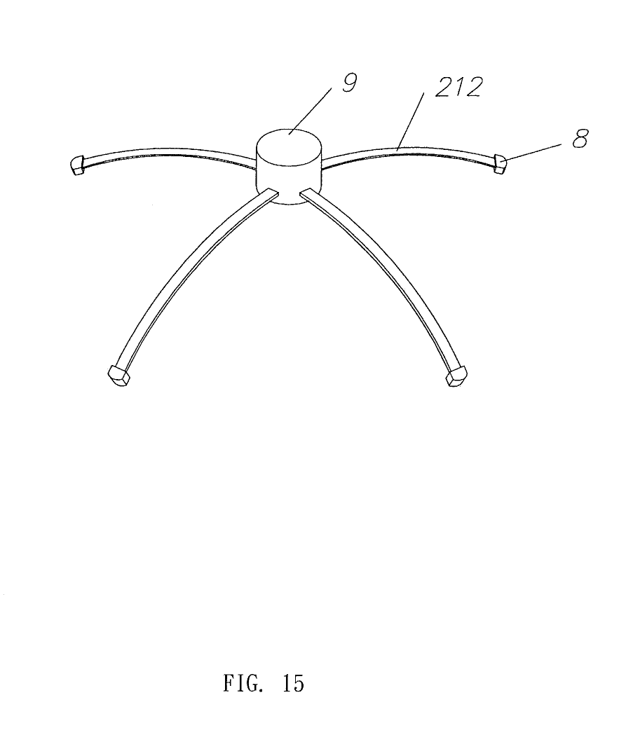

As illustrated in FIG. 15, a plurality of flexible lighting strips 212 are connected with a chandelier seat, and a weight member 8 is hanged on a distal end of each flexible lighting strip 212, thus forming a chandelier.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A flexible power strip for a lamp comprising:
a flexible body, at least one electric circuit unit, at least one LED light element, and any one of an adjusting member, a hooking member, a weight member and a lamp, wherein the flexible body has the at least one electric circuit unit arranged on at least one surface thereof so as to form a flexible power strip, and the flexible power strip is connected with the at least one LED light element so as to form a flexible lighting strip, the flexible power strip is coupled with the flexible lighting strip parallelly or crosswisely so as to produce a flexible lamp;
wherein one end of the flexible lamp is inserted into a notch of the adjusting member and is locked by a locking element of the adjusting member, such that the adjusting member is coupled with the flexible lamp.

2. The flexible power strip for the lamp as claimed in claim 1, wherein the flexible body has a plurality of holes, and one of the plurality of holes hooks with any one of the hooking member, the weight member and the lamp so that the flexible lamp becomes curved.
